(19) United States
(12) Patent Application Publication
(10) Pub. No.: US 2024/0075438 A1
(43) Pub. Date: Mar. 7, 2024

(54) AGITATOR

(71) Applicant: SUMITOMO HEAVY INDUSTRIES PROCESS EQUIPENT CO., LTD., Saijo-shi (JP)

(72) Inventors: Naotaka MAEDA, Saijo-shi (JP); Junich Tsubono, Saijo-shi (JP)

(21) Appl. No.: 18/506,990

(22) Filed: Nov. 10, 2023

Related U.S. Application Data
(63) Continuation of application No. PCT/JP22/28709, filed on Jul. 26, 2022.

(30) Foreign Application Priority Data
Aug. 18, 2021 (JP) 2021-133087

(51) Int. Cl. B01F 27/113; B01F 23/53; B01F 27/072; B01F 27/1145; B01F 27/192; B01F 27/91; B01F 27/92

(52) U.S. Cl. CPC B01F 27/113; B01F 23/53; B01F 27/0725; B01F 27/1145; B01F 27/192; B01F 27/91; B01F 27/92; B01F 2215/0422

(57) ABSTRACT

An agitator includes: an agitation tank that accommodates a fluid to be processed containing particles; a flow blade that agitates the fluid to be processed accommodated in the agitation tank; and a shear blade disposed inside the flow blade at a bottom of the agitation tank to disperse the particles. The shear blade 16 includes a base portion rotating around a predetermined axis and a plurality of blades provided at an edge of the base portion. An angle formed on a downstream side in a rotation direction of the base portion between the blade and a tangent line to an outer periphery of the base portion and each of the blades is 15 degrees or more and 60 degrees or less.

### CROSS-REFERENCE TO RELATED APPLICATIONS

This is a bypass continuation of International PCT Application No. PCT/JP2022/028709, filed on Jul. 26, 2022, which claims priority to Japanese Patent Application No. 2021-133087, filed on Aug. 18, 2021, which are incorporated by reference herein in their entirety.

### BACKGROUND

### Technical Field

A certain embodiment of the present invention relates to an agitator.

### Description of Related Art

In the related art, an agitator that agitates a fluid to be processed has been known. The agitator has various functions depending on properties of the fluid to be processed such as viscosity. For example, an emulsion to be used in hair care products or skin care products is such that an oil phase (for example, silicone oil) is micronized and dispersed in an aqueous phase, and in order to form such an emulsion, there is an emulsifying method for micronizing the oil phase by applying a shearing force to the oil phase. Such an emulsion requires a stable state where dispersed particles are not separated for a long period of time. In addition, in a low-viscosity emulsion, dispersed particles need to have a particle size of a submicron or less. For example, an agitator for such an application is described in the related art.

### SUMMARY

According to one aspect of the present invention, there is provided an agitator including: an agitation tank that accommodates a fluid to be processed containing particles; a flow blade that agitates the fluid to be processed accommodated in the agitation tank; and a shear blade disposed inside the flow blade at a bottom of the agitation tank to disperse the particles. The shear blade includes a base portion rotating around a predetermined axis and a plurality of blades provided at an edge of the base portion. An angle formed on a downstream side in a rotation direction of the base portion between the blade and a tangent line to an outer periphery of the base portion at a position where each of the plurality of blades is fixed to the base portion is 15 degrees or more and 60 degrees or less. Each of the blades is a flat plate having a main surface facing the downstream side in the rotation direction of the base portion, is fixed to the base portion in the vicinity of a center in an up-down direction, and extends upward from a main surface on an upper side of the base portion and downward from a main portion. The fluid to be processed containing the particles micronized by the shear blade flows upward toward a top of the agitation tank.

In addition, according to another embodiment of the present invention, there is provided an agitator including: an agitation tank that accommodates a fluid to be processed containing particles; and a shear blade that disperses the particles contained in the fluid to be processed accommodated in the agitation tank. The shear blade includes a base portion rotating around a predetermined axis and a plurality of blades provided at an edge of the base portion. An angle formed on a downstream side in a rotation direction of the base portion between the blade and a tangent line to an outer periphery of the base portion at a position where each of the plurality of blades is fixed to the base portion is 15 degrees or more and 60 degrees or less. Each of the blades is a flat plate having a main surface facing the downstream side in the rotation direction of the base portion, is fixed to the base portion in the vicinity of a center in an up-down direction, and extends upward from a main surface on an upper side of the base portion and downward from a main surface on a bottom side of the base portion. The fluid to be processed containing the particles micronized by the shear blade flows upward toward a top of the agitation tank.

### BRIEF DESCRIPTION OF THE DRAWINGS

FIG. 1 is a vertical cross-sectional view of an agitator according to an embodiment.

FIG. 2 is a cross-sectional view along a cross section A-A of FIG. 1.

FIG. 3 is a vertical cross-sectional view of the agitator.

FIG. 4 is a top view of a shear blade.

FIG. 5 is a side view of the shear blade.

FIG. 6 is an enlarged view of a region A in FIG. 4.

FIG. 7 is a top view of a shear blade according to a modification example.

FIG. 8 is a graph illustrating an experimental result according to a first example.

FIG. 9 is a graph illustrating experimental results according to a second example.

### DETAILED DESCRIPTION

In recent years, in such an agitator, it has been desired to further micronize the particles in the fluid to be processed. In order to micronize the particles in the fluid to be processed, increasing the rotational speed of a shear blade can be considered. However, there are new problems when the rotational speed of the shear blade is increased, as the energy consumption of the agitator is increased and the life span of consumables such as a seal structure is shortened.

It is desirable to provide an agitator capable of micronizing particles in a fluid to be processed while an increase in energy consumption and preventing the life span of consumables from being shortened.

Hereinafter, an agitator according to an embodiment of the present invention will be described. In the embodiment, an agitator used to emulsify various materials such as cosmetics and foods will be described in detail as an example. The present invention is not limited to the agitator that agitates an emulsion, and is also applicable to an agitator that disperses cellulose nanofibers. In addition, in the following embodiment, an agitator including a plurality of blades that are independently driven will be provided as an example; however, the present invention is also applicable to an agitator including only a shear blade.

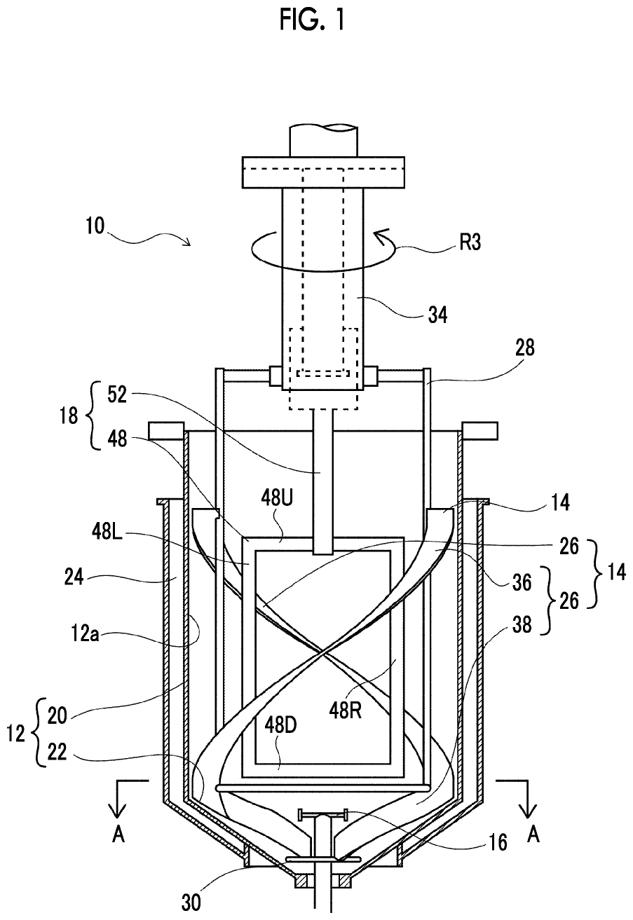

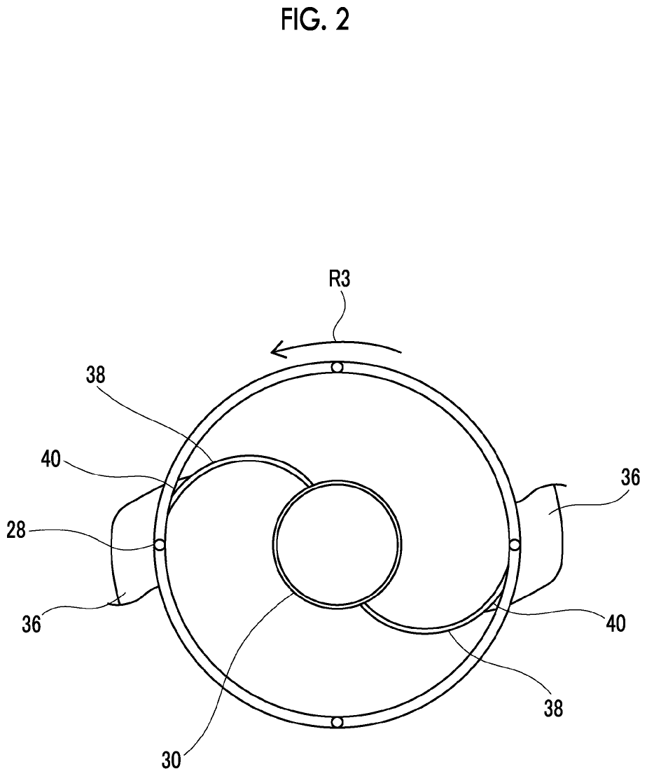

FIG. 1 is a vertical cross-sectional view of the agitator according to the embodiment, and FIG. 2 is a cross-sectional view along a cross section A-A of FIG. 1. As illustrated in FIGS. 1 and 2, an agitator 10 includes an agitation tank 12 that accommodates a fluid to be processed, a flow blade 14, a shear blade 16, and a gate blade 18.

Each of the flow blade 14, the shear blade 16, and the gate blade 18 is accommodated in the agitation tank 12, and is rotationally driven around a drive shaft extending in a vertical direction. The flow blade 14, the shear blade 16, and the gate blade 18 are individually driven by drive units such as motors provided outside the agitation tank 12. Therefore, the flow blade 14, the shear blade 16, and the gate blade 18 are rotatable independently of each other at different rotational speeds in different directions. A rotation direction R3 and rotational speed of the flow blade 14, the shear blade 16, and the gate blade 18 are appropriately determined according to the properties of the fluid to be processed and/or the capacity of the agitation tank 12.

The agitation tank 12 is a container of which an inner peripheral wall 12a has a circular side cross-sectional shape. The agitation tank 12 includes a straight body portion 20 having a cylindrical shape at an upper portion and a throttle portion 22 having a truncated cone shape at a lower portion. The straight body portion 20 and the throttle portion 22 are integrally formed. An inner diameter of the straight body portion 20 is constant in an up-down direction. An inner diameter of the throttle portion 22 decreases toward a bottom. In FIG. 1, an upper end portion of the agitation tank 12 is open, but the upper end portion may be closed. A jacket portion 24 as a heating and cooling portion is formed on an outer portion of the agitation tank 12. A heat medium or a refrigerant flows through the jacket portion 24, and accordingly, the fluid to be processed in the agitation tank 12 can be heated or deheated (cooled).

The flow blade 14 is provided along the inner peripheral wall 12a of the agitation tank 12, and rotates around the drive shaft. The flow blade 14 has a ribbon blade form, and when the flow blade 14 rotates, an induced flow toward the bottom is formed along the inner peripheral wall 12a of the agitation tank 12. When the induced flow is formed in the agitation tank 12, the fluid to be processed is mixed and micronized by the shear blade 16 provided at the bottom.

As illustrated in FIGS. 1 and 2, the flow blade 14 is disposed along the inner peripheral wall 12a of the agitation tank 12, and includes a plurality of flow blade bodies 26 having a predetermined width; a plurality of support rods 28 that support the plurality of flow blade bodies 26 at radially inner positions; and a support ring 30 that connects and supports the flow blade bodies 26 from below. In the illustrated example, two flow blade bodies 26 are provided. The flow blade bodies 26, the support rods 28, and the support ring 30 are integrated by welding or the like. Each of the support rods 28 is a straight rod extending in the up-down direction, and is fixed to the corresponding flow blade body 26 on an upper side and on a lower side. Each of the support rods 28 is connected, via a flow blade drive shaft 34, to a flow blade drive unit (not illustrated) provided above the agitation tank 12. The support ring 30 fixes lower ends of the flow blade bodies 26.

Each of the flow blade bodies 26 is formed in a curved band shape. The flow blade bodies 26 include two upper blades 36 disposed inside the straight body portion 20 and two lower blades 38 disposed inside the throttle portion 22. For example, each of the two upper blades 36 extends to turn around the drive shaft by 180 degrees in a top view. The two upper blades 36 are disposed at an interval of 180 degrees in a top view. For example, the two lower blades 38 extend to turn around the drive shaft by 90 degrees in a top view. The upper blades 36 are disposed at a certain distance from the inner peripheral wall 12a of the agitation tank 12, and extend from a top to the bottom while turning with an inclination at a certain angle in a circumferential direction. When the upper blades 36 rotate, the fluid to be processed inside the straight body portion 20 is agitated and flows toward the bottom.

A diameter of the lower blades 38 corresponds to an inner shape of the throttle portion 22. Specifically, the diameter of the lower blades 38 is slightly smaller than that of the inner peripheral wall of the straight body portion 20 at the top, and is slightly larger than an outer diameter of the drive shaft of the shear blade 16 at the bottom. The lower blades 38 have a shape that is curved to bulge in a direction opposite to the rotation direction R3 in a top view (particularly, refer to FIG. 2).

The upper blade 36 and the lower blade 38 are connected to each other at a joint 40, and both are continuous with each other. Specifically, as illustrated in FIG. 2, the upper blade 36 and the lower blade 38 are connected to each other at the joint 40 by welding or the like in a state where a surface of a band-shaped body forming the lower blade 38 is in contact with a radially inner end edge of a band-shaped body forming the upper blade 36. Accordingly, the upper blade 36 and the lower blade 38 are integrated.

The lower blades 38 direct the fluid to be processed, which is formed by the upper blades 36 and to flow downward while swirling, to the center of the agitation tank 12. Accordingly, the fluid to be processed is guided in a direction of the shear blade 16.

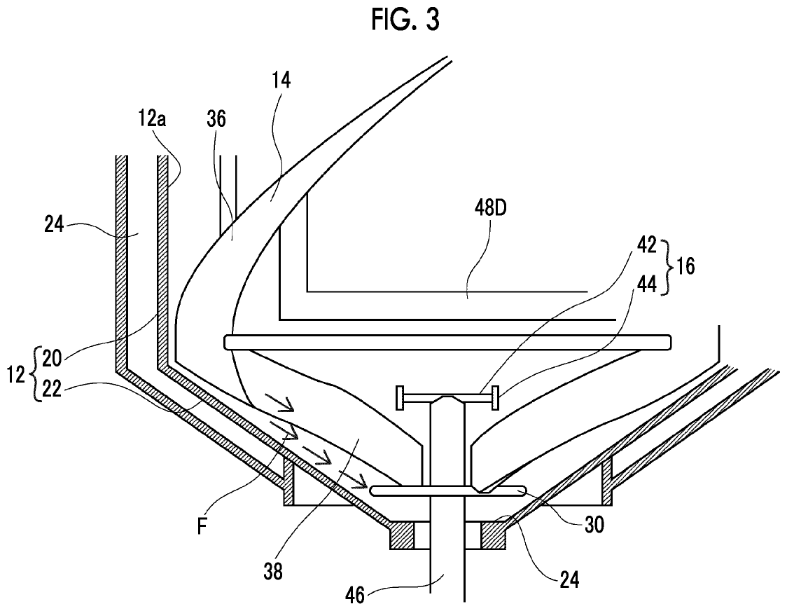

FIG. 3 is a vertical cross-sectional view of the agitator. More specifically, FIG. 3 is an enlarged vertical cross-sectional view of the shear blade and the periphery thereof. The shear blade 16 applies a shearing force to the fluid to be processed through rotation. A dispersion blade is used as the shear blade 16. A configuration of the shear blade 16 will be described later.

A shear blade drive shaft 46 extending downward is connected to the shear blade 16. Although not illustrated, a seal is provided between the agitation tank 12 and the shear blade drive shaft 46 to prevent leakage of an object to be agitated. The shear blade drive shaft 46 is connected to a shear blade drive unit (not illustrated) provided below the agitation tank 12. Accordingly, the shear blade 16 is rotatable around a vertical axis extending in the up-down direction.

Returning to FIG. 1, the gate blade 18 includes a gate blade body 48 formed in a rectangular frame shape that is symmetrical with respect to the center of rotation (vertical axis) as illustrated; and a gate blade drive shaft 52 located above the gate blade body 48 and connected to a gate blade drive unit. The gate blade body 48 is formed by integrally combining an upper horizontal member 48U, a left member 48L, a right member 48R, and a lower horizontal member 48D, each of which is formed in a rod shape, and has a frame structure formed of elongated rod-shaped members. The gate blade 18 rotates in the opposite direction with respect to the flow blade 14, or rotates in the same direction as that of the flow blade 14 at a rotational speed different from that of the flow blade 14. A gate blade drive unit (not illustrated) for rotating the gate blade 18 is located above the agitation tank 12. The gate blade drive shaft 52 is disposed concentrically with the flow blade drive shaft 34. The gate blade drive unit can also serve as the flow blade drive unit. In this case, the gate blade drive unit is configured to supply driving forces with different rotational speeds (or different rotation directions) to the flow blade 14 and the gate blade 18 via a speed reducer and the like. The rotational speeds of the flow blade 14 and the gate blade 18 are set to be sufficiently slower than that of the shear blade 16. In addition, while the flow blade 14 and the shear blade 16 rotate, the gate blade 18 may maintain a stationary state without rotating at all.

The combination of the flow blade 14 and the gate blade 18 causes a difference in speed between the movement of the object to be agitated caused by the rotation of the gate blade 18 and the movement of the object to be agitated caused by the rotation of the flow blade 14 in the agitation tank 12. For this reason, “co-rotation” in which the object to be agitated moves in unison with the flow blade 14 in the agitation tank 12 can be suppressed, and the object to be agitated is allowed to smoothly flow throughout the agitation tank 12.

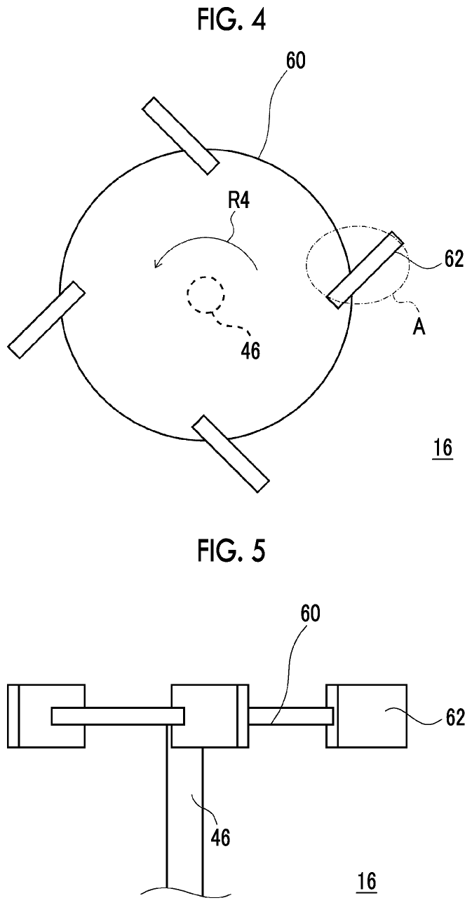

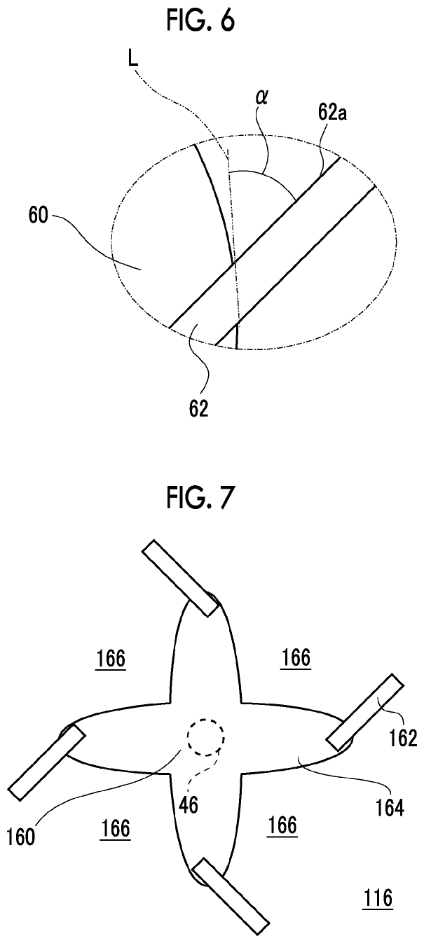

FIG. 4 is a top view of the shear blade, and FIG. 5 is a side view of the shear blade. In addition, FIG. 6 is an enlarged view of a region A in FIG. 4. As illustrated in FIGS. 4 to 6, the shear blade 16 rotates in a direction perpendicular to the flow of the fluid to be processed toward the shear blade 16 along the shear blade drive shaft 46, to apply a shearing force to the fluid to be processed. The shear blade 16 is disposed inside the flow blade 14 at the bottom of the agitation tank 12. In FIG. 4, a base portion 60 is assumed to rotate in a counterclockwise direction (indicated by arrow R4) in a top view. The shear blade 16 includes the base portion 60 and a plurality of blades 62. The base portion 60 is formed of a flat disk-shaped plate, and is fixed to an upper end surface of the shear blade drive shaft 46. The base portion 60 is fixed to the shear blade drive shaft 46 such that the center of the base portion 60 when viewed from above overlaps a rotation axis of the shear blade drive shaft 46. Therefore, the base portion 60 is coaxial with the shear blade drive shaft 46, and is rotationally driven together with the shear blade drive shaft 46.

The plurality of blades 62 are fixed to the base portion 60 along an edge of the base portion 60. The plurality of blades 62 turn around the vertical axis along with the rotation of the base portion 60, and accordingly, collide with the fluid to be processed to act a shearing force on the fluid to be processed. Each of the plurality of blades 62 is formed of a rectangular flat plate. Sides of the blades 62, which extend in the up-down direction, are parallel to the shear blade drive shaft 46. Sides of the blades 62, which extend in a horizontal direction, are parallel to main surfaces of the base portion 60. The blades 62 are fixed to the edge of the base portion 60 by, for example, welding. The plurality of blades 62 are disposed at equal angular intervals with respect to the center of the base portion 60. The blades 62 may be fixed to the base portion 60 in the vicinities of the centers of the blades 62 in the up-down direction. In that case, in a side view, the blades 62 extend upward from the main surface on an upper side of the base portion 60, and extend downward from the main surface on a bottom side of the base portion 60. When viewed from above, tips (outer ends in a radial direction of the base portion 60) of the blades 62 face a downstream side in the rotation direction of the base portion 60. The plurality of blades 62 have a predetermined angle α with respect to a tangent line L to an outer periphery of the base portion 60. The tangent line L is a tangent line at a position where each of the blades 62 is fixed to the base portion 60. The angle α refers to an acute angle formed between the tangent line to the outer periphery of the base portion 60 and a main surface 62a (main surface facing the downstream side in the rotation direction and colliding with the fluid to be processed) of the blade 62 when viewed from above. The angle α is preferably larger than 0 and 60 degrees or less, more preferably 15 degrees or more and 45 degrees or less, and is even more preferably 20 degrees or more and 40 degrees or less. From experiments by the inventors and others, it has been found that by setting the angle α within the foregoing range, the shearing force applied to the fluid to be processed can be increased and particles contained in the fluid to be processed can be further micronized.

In the present embodiment, a flat plate of which the main surface 62a is flat is used as the blade 62. However, a blade of the main surface 62a that is curved may be used as the blade 62. In this case, the angle α refers to an angle between a tangent line to the main surface 62a at the point where the base portion 60 and the blade 62 are fixed and the tangent line to the outer periphery of the base portion 60.

Next, the operation of the agitator 10 will be described. Referring to FIGS. 1 to 3, when the fluid to be processed is put into the agitation tank 12, and the gate blade drive unit, the flow blade drive unit, and the shear blade drive unit are turned on, each of the flow blade 14, the shear blade 16, and the gate blade 18 is rotationally driven in a direction determined in advance. Accordingly, the flow blade bodies 26 push the fluid to be processed inside the straight body portion 20 toward the bottom, and an induced flow F toward the bottom along the inner peripheral wall 12a in the agitation tank 12 is generated. The fluid to be processed is continuously supplied to the shear blade 16 by the induced flow F.

The flow of the fluid to be processed supplied to the shear blade 16 flows toward the top along the shear blade drive shaft 46. In the vicinity of the shear blade 16, a shearing force acts on the fluid to be processed due to the rotation of the shear blade 16, and the particles contained in the fluid to be processed are micronized in the fluid to be processed. Thereafter, the fluid to be processed flows upward toward the straight body portion 20. The fluid to be processed repeats a series of circulation in which the fluid to be processed is agitated inside the straight body portion 20 by the upper blades 36 and is supplied to the shear blade 16.

A phenomenon in the vicinity of the shear blade 16 will be described in more detail. Referring to FIGS. 4 to 6, when the fluid to be processed reaches the vicinity of the shear blade 16, the fluid to be processed comes into contact with the shear blade 16. When the fluid to be processed comes into contact with the main surfaces 62a of the blades 62, a shearing force acts on the fluid to be processed, and the particles in the fluid to be processed are micronized. In addition, by setting the angle α within the above-described range, the shearing force can be increased, and the particles in the fluid to be processed can be further micronized. Accordingly, even when the rotational speed of the shear blade 16 is set to be low, it is possible for a the micronizing effect to occur which is equal to or higher than in a case where the shear blade is rotated at high speed in an agitator in which the angle of the blades is not adjusted. By maintaining the rotational speed of the shear blade 16 at low speed, the life span of consumables including, for example, the seal between the agitation tank 12 and the shear blade drive shaft 46 can be extended. In addition, heat generation caused by the rotation of the shear blade drive shaft 46 can be suppressed, and the in-tank temperature can be controlled to a satisfying extent.

Next, a modification example of the embodiment will be described.

FIG. 7 is a top view of a shear blade of an agitator according to a modification example. As illustrated in FIG. 7, a base portion 160 of a shear blade 116 has a cross shape in a top view. The base portion 160 includes four protrusion portions 164 protruding outward in the radial direction. Each of the plurality of blades 162 is fixed to a tip of the protrusion portion 164. The base portion 160 can be said to include cutouts in which an edge of the base portion 160 is recessed toward a center side, compared to the base portion 60 described above. The cutouts act as flow paths 166 through which the fluid to be processed flows from a bottom side of the base portion 160 toward the upper side. Each of the flow paths 166 is formed between the protrusion portions 164 adjacent to each other.

Next, the action of the modification example will be described. As described above, when the agitator is driven, a flow from the bottom side toward the upper side is generated in the vicinity of the shear blade 116. By providing the flow paths 166 in the base portion 160, when the shear blade 116 is rotated, the fluid to be processed flows from a bottom side of the shear blade 116 toward the upper side through the flow paths 166. When the shear blade 116 rotates, side surfaces of the base portion 160, which define the flow paths 166, come into contact with the fluid to be processed in the flow paths 166, so that the shearing force applied to the fluid to be processed can be increased. The shape or number of the flow paths 166 is not limited to the illustrated example, and various shapes and numbers can be adopted as long as the fluid to be processed can flow from the bottom side of the base portion 160 toward the upper side. In addition, the side surfaces of the shear blade 116, which define the flow paths 166, may be inclined.

A through-hole formed in the base portion 160 may be used as the flow path. The positions or number of the through-holes are not particularly limited.

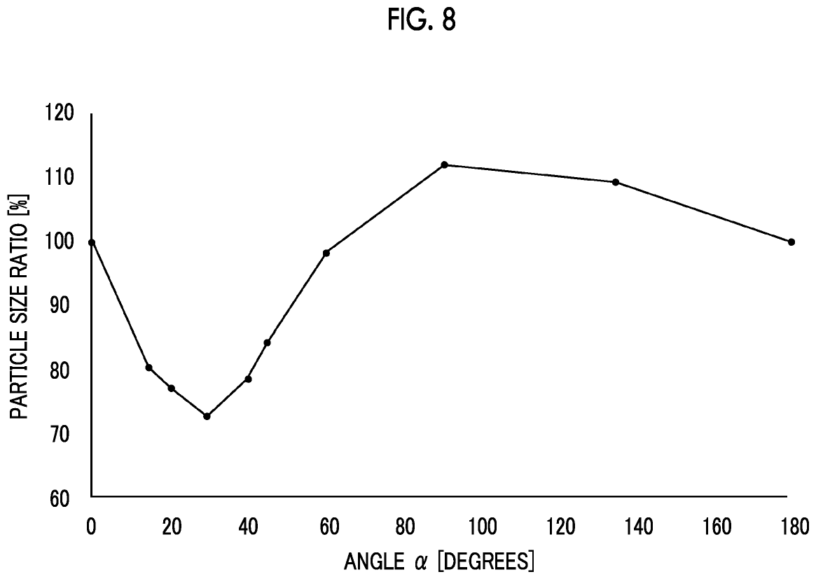

Hereinafter, examples of the present invention will be described. FIG. 8 is a graph illustrating an experimental result according to a first example. In the experiment, a change in particle size ratio when the shear blade was rotated at a constant rotational speed in the agitation tank with a constant capacity to change the angle α was observed. In the graph of FIG. 8, the horizontal axis represents the angle α, and the vertical axis represents the particle size ratio. For the particle size ratio, a particle size ratio when the angle α is 0 degrees is defined as 100%. As can be seen from FIG. 8, when the angle α is larger than 0 degrees and 60 degrees or less, the particle size ratio is 100% or less. In addition, it can be seen that the particle size ratio is approximately 85% or less when the angle α is 15 degrees or more and 45 degrees or less. In addition, it can be seen that the particle size ratio is approximately 78% or less when the angle α is 20 degrees or more to 40 degrees. In such a manner, the particle size ratio can be reduced by setting the angle α within a predetermined range.

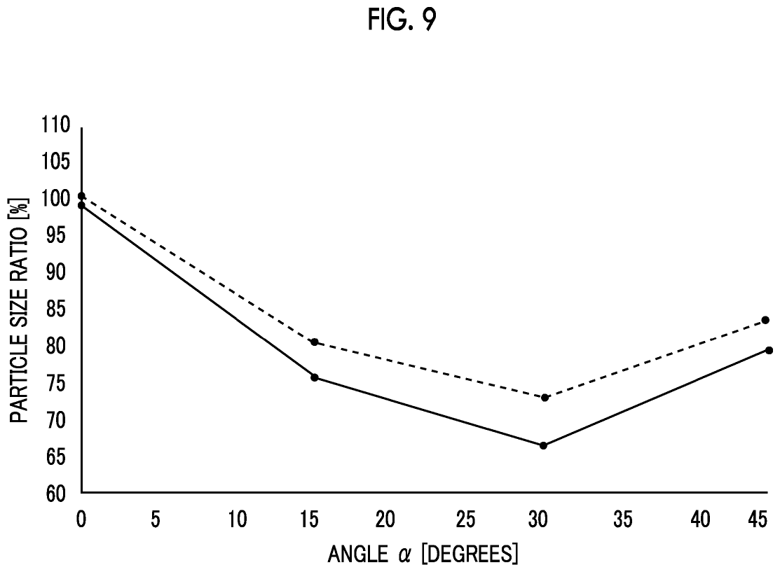

FIG. 9 is a graph illustrating experimental results according to a second example. In the experiments, the same experiment as in the first example was performed on each of the shear blade including the flow paths (shear blade illustrated in FIG. 7) and the shear blade not including the flow path, and changes in particle size ratio were observed. In the graph of FIG. 9, the horizontal axis represents the angle α, and the vertical axis represents the particle size ratio. For the particle size ratio, a particle size ratio when the angle α is 0 degrees is defined as 100%. A broken line in FIG. 9 indicates a change in particle size ratio when the shear blade not including the flow path is used, and a solid line indicates a change in particle size ratio when the shear blade including the flow paths is used. It can be seen that when the angles α are the same, the particle size ratio is smaller when the shear blade including the flow paths is used.

The present invention is not limited to the above-described embodiment, and the configuration of the embodiment can be changed as appropriate without departing from the concept of the present invention.

The present invention relates to an agitator.

It should be understood that the invention is not limited to the above-described embodiment, but may be modified into various forms on the basis of the spirit of the invention. Additionally, the modifications are included in the scope of the invention.

What is claimed is:

1. An agitator comprising:
an agitation tank that accommodates a fluid to be processed containing particles;
a flow blade that agitates the fluid to be processed accommodated in the agitation tank; and
a shear blade disposed inside the flow blade at a bottom of the agitation tank to disperse the particles,
wherein the shear blade includes a base portion rotating around a predetermined axis and a plurality of blades provided at an edge of the base portion,
an angle formed on a downstream side in a rotation direction of the base portion between the blade and a tangent line to an outer periphery of the base portion at a position where each of the plurality of blades is fixed to the base portion is 15 degrees or more and 60 degrees or less,
each of the blades is a flat plate including a main surface facing the downstream side in the rotation direction of the base portion, is fixed to the base portion in the vicinity of a center in an up-down direction, and extends upward from a main surface on an upper side of the base portion and downward from a main surface on a bottom side of the base portion, and
the fluid to be processed containing the particles micronized by the shear blade flows upward toward a top of the agitation tank.

2. The agitator according to claim 1,
wherein the agitator drives the shear blade at a low rotational speed.

3. The agitator according to claim 1, further comprising:
a shear blade drive shaft connected to the shear blade and extending downward,
wherein each of the blades is formed of a rectangular flat plate, a side of each of the blades extending in the up-down direction is parallel to the shear blade drive shaft, and a side of each of the blades extending in a horizontal direction is parallel to the main surfaces of the base portion.

4. The agitator according to claim 1,
wherein the angle formed on the downstream side in the rotation direction of the base portion between the blade and the tangent line to the outer periphery of the base portion is 45 degrees or less.

5. The agitator according to claim 1,
wherein the base portion has a disk shape, and is disposed in the agitation tank such that a center of the disk overlaps the predetermined axis.

6. The agitator according to claim 1,
wherein the base portion includes a flow path through which the fluid to be processed flows from a bottom side to a top side of the agitation tank.

7. An agitator comprising:
an agitation tank that accommodates a fluid to be processed containing particles; and
a shear blade that disperses the particles contained in the fluid to be processed accommodated in the agitation tank,
wherein the shear blade includes a base portion rotating around a predetermined axis and a plurality of blades provided at an edge of the base portion,
an angle formed on a downstream side in a rotation direction of the base portion between the blade and a tangent line to an outer periphery of the base portion at a position where each of the plurality of blades is fixed to the base portion is 15 degrees or more and 60 degrees or less,
each of the blades is a flat plate including a main surface facing the downstream side in the rotation direction of the base portion, is fixed to the base portion in the vicinity of a center in an up-down direction, and extends upward from a main surface on an upper side of the base portion and downward from a main surface on a bottom side of the base portion, and
the fluid to be processed containing the particles micronized by the shear blade flows upward.
